(19) United States
(12) Patent Application Publication
(10) Pub. No.: US 2017/0095892 A1
(43) Pub. Date: Apr. 6, 2017

(54) CROSS FLOW TABLE

(71) Applicant: RoboVent Products Group, Inc., Sterling Heights, MI (US)

(72) Inventors: John Reid, Royal Oak, MI (US); James Reid, Blacklick, OH (US)

(21) Appl. No.: 15/283,618

(22) Filed: Oct. 3, 2016

Related U.S. Application Data
(60) Provisional application No. 62/235,675, filed on Oct. 1, 2015.

(51) Int. Cl. B23K 37/00; B24B 55/00; B08B 15/02; B23K 37/04

(52) U.S. Cl. CPC B23K 37/006; B23K 37/0461; B24B 55/00; B08B 15/023

(57) ABSTRACT

A crossflow table having a housing and a work surface. The housing includes an air intake path in fluid communication with the work surface. The air intake path has an intake entrance and intake exit. A filter and blower unit are positioned adjacent the intake exit. An air exhaust path has an exhaust entrance and exhaust exit. The exhaust entrance is adjacent the filter and blower unit. The air intake path and air exhaust path generally extend parallel to one another. The filter and blower unit draw air into the air intake path at the intake entrance and pull the air though the air intake path where the air exhausts into the filter and blower unit at the intake exit. The blower unit then pushes the air into the air exhaust path at the exhaust entrance and forces the air through the air exhaust path and out the exhaust exit. Due to the intake and exhaust paths being generally parallel to one another, the crossflow table is very compact in overall dimensions.

### RELATED APPLICATIONS

This application claims the benefit of U.S. Provisional Application No. 62/235,675 filed Oct. 1, 2015, which is incorporated herein by reference in its entirety.

### STATEMENT REGARDING FEDERALLY SPONSORED RESEARCH

NONE.

### TECHNICAL FIELD

This invention relates generally to work tables and more specifically to work tables used in operations that create airborne contaminants such as for example, welding fumes, grinding dust, etc.

### BACKGROUND OF THE INVENTION

The present invention generally relates to work tables, particularly work tables used for welding, grinding, etc. For example, work tables used in welding operations are typically heavy metal tables used to support the material to be welded. The tables are usually defined by a table top made of metal supported on metal legs. Some tables may also include side partitions to shield the welding operation.

As will be appreciated, welding operations create fumes and other airborne contaminants. Typically, the fumes are drawn into an air filtering system which filters the contaminants from the air and returns the filtered air to the work environment. The filtering system usually includes for example a work station and filter unit. The work station is typically an enclosed area surrounding the work table. The filter unit is operatively connected to the work station and draws air from the work station to filter the air.

In another example, a fume arm is used to extract and filter the contaminated air produced at the work table. These units can take various forms, but generally there is an air filter unit with a movable arm that can be moved into proximity to the work area. The fume arm pulls the contaminants from the area and the air is filtered through the air filtering unit.

Another example is known as a downdraft table where the work operations are performed on a slotted table or bar grate work surface or similar perforated surface. With this type of table, the contaminated air is drawn vertically down through the work surface, and then filtered through the air filtering unit

Known work tables and associated air filter systems generally require a large amount of floor space which is costly. The work table and air filtering unit are separate and generally require their own floor space. Additionally, the known units are not easily moved to different locations if desired. Also, the typical work tables and associated filter units cannot be arrayed easily to conserve space. An efficient array of multiple workstations is very desirable in applications such a welding training school to maximize the number of workstations that are able to be accommodated in a given area.

In some of the above examples, in particular the downdraft table, the generated fume is not captured in an effective manner, due to attempting to draw the air downwards when the positive buoyancy of the heated air and fume from welding operations or similar is causing the fume to rise and escape from being captured and filtered.

In addition, many of the above examples discharge the filtered air at the sides of the air filter unit, which either prohibits the workstations and filter units being placed closely adjacent side to side or back to back as the discharge area would become obstructed, or the air is blown forward toward the operator at the workstation causing annoyance and discomfort.

It is desirable to provide a self-contained work table and air filtering unit. A desirable work table and filtering unit would be compact to reduce the floor space required. Additionally, the work table and air filtering unit would be capable of being arrayed in the most desirable array to efficiently take advantage of available floor space. The work table would also efficiently and effectively filter the air and discharge the filtered air.

### SUMMARY OF THE INVENTION

In general terms, this invention provides a compact work table and air filtering system in a single unit. The unit includes a housing with side panels and a back panel that have no protrusions which allows the unit to be arrayed side by side and back to back with other units to efficiently take advantage of available floor space. The unit houses a self-contained air filtering unit which employs a unique cross flow system to keep the system compact. The air intake path and the air exhaust path of the cross flow system are generally parallel to reduce the size of the unit.

The unit has access panels at the front of the unit for access to the operational components, the blower and fan and the filter. Having the access panels at the front allows easy access. The unit front also provides a unique cleanout system for removing particulates that are discharged during cleaning. The particulates are discharged from the filter and collected along a trough. The trough is operatively connected to a port that is adapted to receive a vacuum to vacuum the particulates form the trough.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the cross flow table of the present invention.

FIG. 2 is a perspective view of the cross flow table of the present invention with illustrating the filter access panel.

FIG. 3 is a cutaway side view of the cross flow table of the present invention.

FIG. 4 is a side view of the cross flow table of the present invention.

FIG. 5 is a view taken along section D-D of FIG. 4.

FIG. 6 is an enlarged view taken along the detail E of FIG. 5.

### DETAILED DESCRIPTION OF A PREFERRED EMBODIMENT

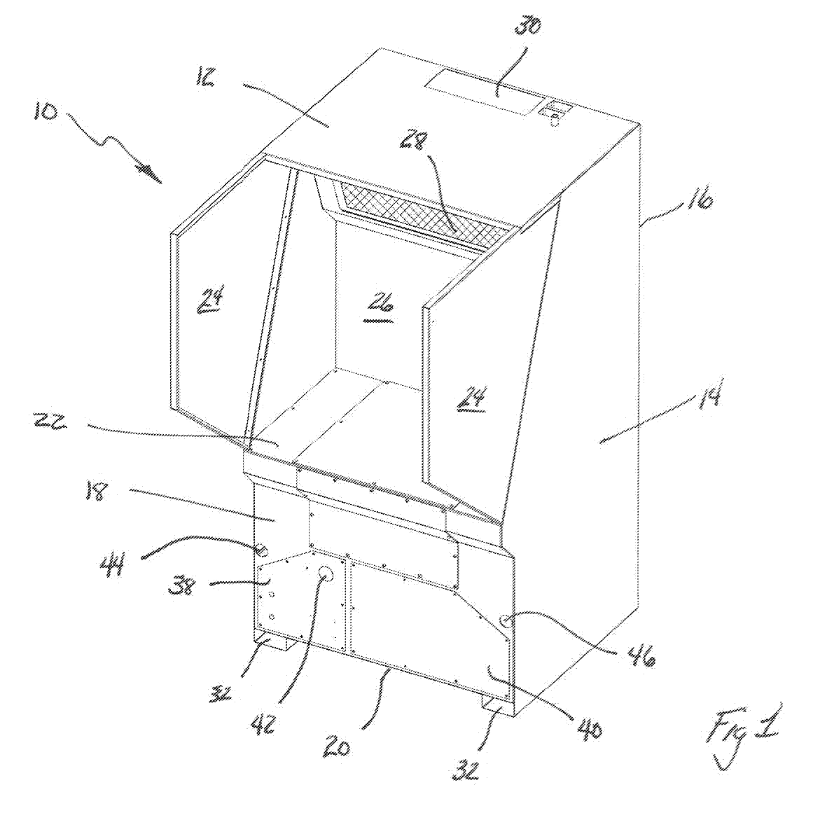

The cross flow table of the present invention is shown generally at 10 in FIG. 1. The cross flow table 10 has an outer housing defined generally by a top panel 12, side panels 14, a back panel 16, a face panel 18 and a bottom panel 20. The housing has been intentionally designed so that there are no protrusions on the side panels 14 or back panel 16. This permits a number of cross flow tables 10 to be closely positioned adjacent one another to define an array of crossflow tables 10. The crossflow tables 10 of the present invention can be positioned side-by-side as well as back up back to define various arrays for specific work environments. As will be described in greater detail below, all the working components of the cross flow table of the present invention are contained within the housing, allowing for nothing to protrude from the sides 14 or back 16.

Fork lift pockets 32 are provided on the bottom 20 to facilitate easy movement of the table 10 by a forklift. It will be appreciated by those of ordinary skill that other moving devices could be used to move the table 10, such as for example, wheels, tracks, skids, etc.

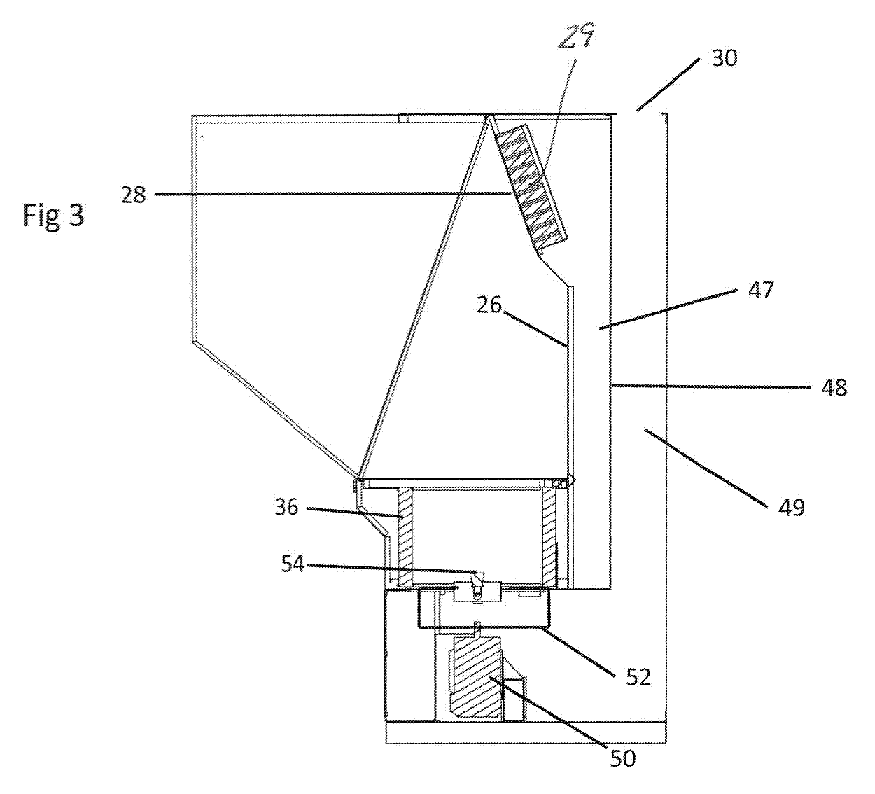

The cross flow housing 10 has a work surface 22, side walls or partitions 24 and an exposed back wall 26 defining an open workspace area. Positioned between the top panel 12 and the back wall 26 is an air intake 28 which in the disclosed embodiment includes a spark arrestor, see FIG. 3. The spark arrestor is positioned over the air intake 28 to capture sparks, which may be developed during the welding process. Spark arrestors of various kinds are well known to those of ordinary skill the art. The air intake 28 draws in dirty air for filtering from the work area defined by the work surface 22, partitions 24 and the back wall 26. In the disclosed embodiment, the position of the air intake is higher to maximize its effectiveness at capturing hot contaminated air and fumes as the positive buoyancy causes the fume to rise up to the intake 28. Also, with the intake positioned further backward the fume is drawn away from the operators breathing zone which is of primary importance to reduce fume exposer to the operator.

The cross flow table can also include front access panels 38 and 40 which provide easy access to the blower unit which includes the motor and blower 50 and 52 respectively shown in FIG. 3.

Additionally in FIG. 1 there is a gauge connection aperture 42 for connection to a differential pressure minihelic gauge to show filter condition. Cleanout ports 44 and 46 are also provided and will be described in greater detail below.

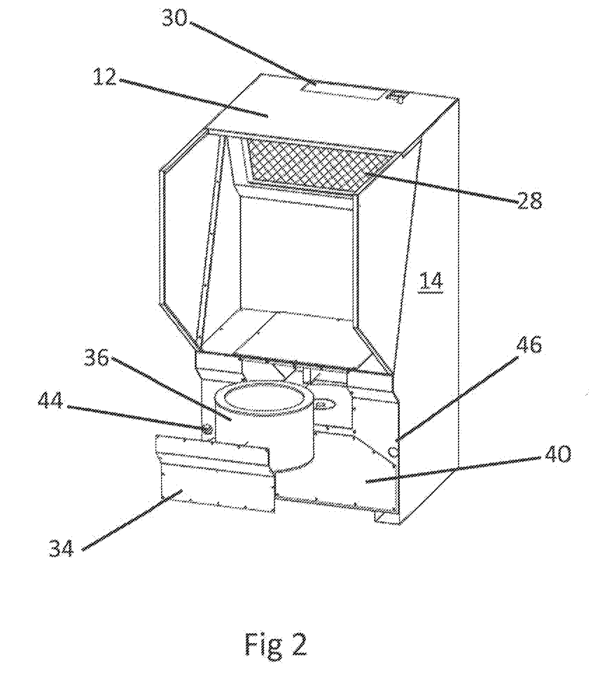

With reference to FIGS. 2 and 3, a filter 36 is provided below the work surface 22. In the disclosed embodiment, a filter access panel 34 is provided for easy access to the filter 36. By removing bolts or screws, the filter access panel 34 can be removed for easy access to the filter 36 for maintenance, such as filter replacement.

In the disclosed embodiment, the filter 36 is a hollow cylindrical style filter. It will be appreciated by those of ordinary skill in the art that other types of filters could be used, for example flat filters, bag filters, etc.

Referring more specifically to FIG. 3, a cross section of the cross flow table 10 is illustrated. As illustrated in FIG. 3, the air intake 28 is in operable communication with the filter 36 through a flow path 47 which channels air pulled into the air intake 28 by the blower fan 52. The air contains contaminants and is pulled through the filter 36 by the blower fan 52 and then forced out through the exhaust flow path filter or air plenum 49 to the air exhaust 30. As illustrated, air is pulled down flow path 47, through filter 36 and then pushed up along the exhaust flow path or filtered air plenum 49 and out of air exhaust 30. _{[h1]}The intake air flow path is generally defined by the work area back wall 26 and an inner wall 48. The work area wall 26 and inner wall 48 are spaced from each other with the inner wall 48 extending from the top panel 12 down to an interior floor 60. The work area back wall 26, inner wall 48 and interior floor 60 combine to define the intake air flow path 47. As described above, the intake air flow path begins at the air intake and generally ends at the filter 36. Air drawn into the air intake path 47 by the blower motor and fan 50 and 52 respectively is drawn in through the intake 28 and into the filter 36. The air pulled into the filter 36 is then pulled through the filter 36 and pushed through the filtered air plenum 49. The filtered air plenum 49 is defined by the inner wall 48 and the back panel 16. It will be appreciated by those of ordinary skill in the art that either the intake air flow path 47 or the exhaust air plenum 49 or both could be further defined by having side walls which are different than the side panels 14 of the crossflow table 10.

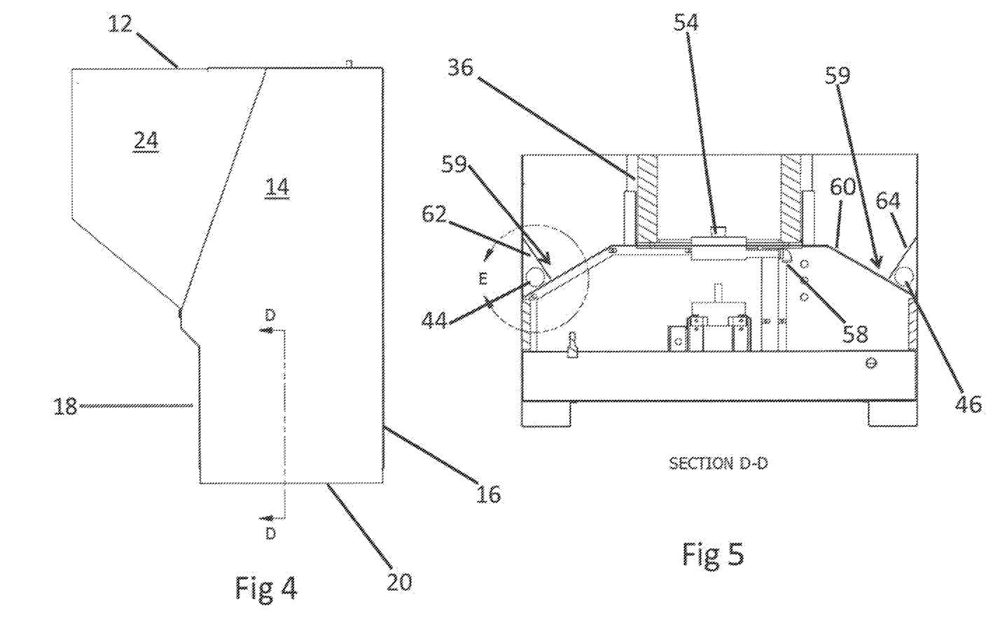

With reference to FIGS. 3 through 6, the cleaning function of the present invention will be described. With reference to FIGS. 3 and 5, a pulse tube 54 is shown. In the disclosed embodiment, the pulse tube 54 is operatively connected to a compressed air supply. Typically, the compressed air supply is provided within the work environment housing the cross flow table 10. A compressed air connection 58, shown in FIG. 5 is provided to operatively connect the pulse tube 54 to the compressed air supply. The source of compressed air would be coupled to the compressed air connector 58 to supply compressed air through the pulse tube 54 when required by the control module 56.

The pulse tube 54 is used to inject compressed air into the interior of filter 36 to blow contaminants off the outer surface of filter 36 into a collection trough 59. In the disclosed embodiment, there are two collection troughs 59 on opposed sides of the filter 36. When the gauge, not shown, coupled through the gauge access port 42 indicates that the filter 36 has reached a certain level of contamination, the operator through manual operation will reverse pulse compressed air through the pulse tube 54 to create a positive pressure within the filter 36 blowing the contaminant from the outside of the filter 36 into the collection trough 59. In this way, the filter 36 can be repeatedly cleaned during operation and increase the life of the filter 36 substantially.

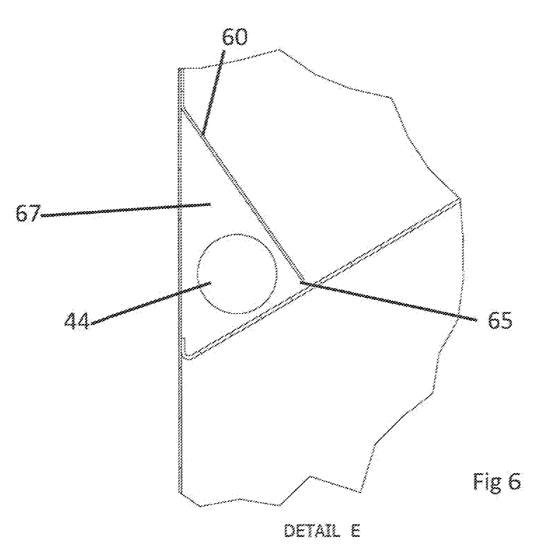

With reference to FIG. 6, an accumulation of contaminants is illustrated having been received within the collection trough 59. The collection trough 59 is defined by the interior floor 60 and the dust collection walls 62 and 64 which in the disclosed embodiment are mounted at an angle with respect to the downward sloping walls of the interior floor 60.

In the disclosed embodiment, the collection trough 59 extends the full-length from the front panel 14 to the interior work area back wall 26. A suction gap 65 is created between the dust collection walls 62 and 64 and the interior floor 60. This gap in the disclosed embodiment is approximately 3/16 inches wide and extends the length of the collection trough 59. The gap 65 is in fluid communication with a suction chamber 67 which is in turn in fluid communication with the cleanout ports 44 and 46. In operation, a suction device, such as a shop vacuum with a hose and nozzle attachment can be inserted in to the ports 44 and 46 to create a vacuum within the suction chamber 67. This in turn creates a large vacuum at the very small gaps 65 to then suck the contaminants within the collection trough 59 through the gap 65 and out the ports 44 and 46 respectively.

In operation, a worker, for example a welder, will weld upon the work table 22 creating welding fumes. The blower motor 50 will be energized and blower fan 52 will pull air within the work area into the air intake 28. The air is then pulled through the intake air flow path and into the filter 36. The filter 36 allows air to pass through and retains the contaminants in the filter 36. The filtered air then passes through the exhaust flow path 49 and exits through the air exhaust 30.

As the contaminants accumulate on the filter 36, the effectiveness of the filter 36 is reduced. At a pre-determined accumulation, the filter 36 must be cleaned to ensure continued effectiveness. The differential pressure minihelic gauge will indicate when the filter 36 needs to be cleaned. Once the gauge indicates that cleaning is needed, the operator will manually initiate the cleaning cycle.

The cleaning cycle includes the reverse pulse of compressed air into the pulse tube 54. The pulse tube 54 injects compressed air into the interior of the filter 36. The compressed air blows the contaminants from the filter 36 and into the trough 59. The cleaning process can be done during operation of the blower motor 50 or when the blower motor 50 is not operational. The particulate from the filter 36 accumulates in the trough 59 and can be removed through the ports 44 and 46. To remove the accumulated particulates, a vacuum, such as a shop vacuum is inserted into the ports 44 and 46 to suck out the particulates. As described above, the particulates are pulled through the gap 65 into the suction chamber 67 and into to the vacuum.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A crossflow table comprising:
a housing having a top panel, side panels, a back panel and a front panel;
a work surface positioned within said housing defining an open work space area, said open work space area being defined by side walls and a back wall;
an air intake mounted above said work surface said air intake positioned adjacent said top panel and said back wall and an air exhaust positioned adjacent said back panel and said top panel;
an inner wall positioned between said back panel and said back wall, said inner wall being generally parallel to said back panel and said back wall, and an interior floor spaced from said work surface and generally parallel to said work surface, said inner wall extending from said top panel to said interior floor;
a filter compartment positioned between said work surface and said interior floor;
a filter mounted within said filter compartment;
a blower compartment positioned below said interior floor in operative communication with said filter compartment;
a blower mounted within said blower compartment;
an intake air flow path defined by said back wall and said inner wall, said intake air flow path being in operative communication with said filter compartment and said air intake, whereby said blower draws air into said air intake, through said air intake flow path and through said filter;
a filtered air plenum defined by said back panel and said inner wall, said filtered air plenum being in operative communication with said blower compartment, whereby filtered air is exhausted from said blower compartment through said filtered air plenum and out said air exhaust.

2. The crossflow table of claim 1, further including a spark arrestor mounted in said air intake.

3. The crossflow table of claim 1, further including a pulse tube for reverse pulsing compressed air into said filter to clean said filter.

4. The crossflow table of claim 1, further including at least one trough positioned within said filter compartment for collecting debris.

5. The crossflow table of claim 4, wherein said trough extends from said front panel to said interior back wall.

6. The crossflow table of claim 4, further including a suction chamber in fluid communication with said trough, said suction chamber allowing the withdrawal of debris from said trough through said suction chamber.

7. The crossflow table of claim 6, further including a suction gap at the base of said trough, said suction gap in fluid communication with said suction chamber.

8. The crossflow table of claim 7, wherein said suction gap extends the length of said trough.

9. The crossflow table of claim 1, wherein said side panels and back panel are unobstructed whereby additional crossflow tables can be abutted against said side panels or back panels to form an array of crossflow tables.

10. A crossflow table comprising:
a housing;
a work surface;
said housing including an air intake path in fluid communication with said work surface, said air intake path having an intake entrance and intake exit;
a filter and blower unit positioned adjacent said intake exit;
an air exhaust path having an exhaust entrance and exhaust exit; said exhaust entrance being adjacent said filter and blower unit;
said air intake path and air exhaust path generally extending parallel to one another;
whereby said filter and blower unit draw air into said air intake path at said intake entrance and pull the air though the air intake path where the air exhausts into said filter and blower unit at said intake exit, said blower unit then pushing the air into said air exhaust path at said exhaust entrance and forcing the air through said air exhaust path and out said exhaust exit.

11. The crossflow table of claim 10, wherein said housing has an inner wall, said air intake path and said air exhaust path are separated by said inner wall.

12. The crossflow table of claim 11, wherein said housing has a back panel and said work surface has a back wall, said an inner wall is positioned between said back panel and said back wall, said inner wall being generally parallel to said back panel and said back wall.

13. The crossflow table of claim 12, wherein said housing further includes an interior floor spaced from said work surface and generally parallel to said work surface, said inner wall extending interior floor.

14. The crossflow table of claim 10, further including a spark arrestor mounted within said intake entrance.

15. The crossflow table of claim 10, further including a pulse tube for reverse pulsing compressed air into said filter to clean said filter.

16. The crossflow table of claim 10, further including at least one trough positioned within said housing for collecting debris.

17. The crossflow table of claim 16, further including a suction chamber in fluid communication with said trough, said suction chamber allowing the withdrawal of debris from said trough through said suction chamber.

18. The crossflow table of claim 17, further including a suction gap at the base of said trough, said suction gap being in fluid communication with said suction chamber.

19. The crossflow table of claim 18, wherein said suction gap extends the length of said trough.

20. The crossflow table of claim 16, wherein said housing has two troughs positioned on opposite sides of said filter.
